(19) United States
(12) Patent Application Publication
(10) Pub. No.: US 2024/0027219 A1
(43) Pub. Date: Jan. 25, 2024

(54) Tracking System And Method

(71) Applicant: MORGAN OLSON LLC, Sturgis, MI (US)

(72) Inventors: Ernest McKinley McDonald, II, Granger, IN (US); Jessie Michael Dowell, Fremont, IN (US); James Allen Honey, Elkhart, IN (US); Kyle Brennan Wolthuis, Sturgis, MI (US); Christopher John Van Meter, Three Rivers, MI (US)

(21) Appl. No.: 18/357,718

(22) Filed: Jul. 24, 2023

Related U.S. Application Data
(60) Provisional application No. 63/391,426, filed on Jul. 22, 2022.

(51) Int. Cl. G01C 21/36; H04W 4/029

(52) U.S. Cl. CPC G01C 21/3667; H04W 4/029

(57) ABSTRACT

A method is disclosed for tracking vehicle and vehicle components. The method includes receiving, from a first computing device having a geolocation device, an identifier associated with an object, such as, for example, a vehicle or component of a vehicle. The identifier associated with the object can be associated, by the first computing device, with a location from the geolocation device. The identifier associated with the vehicle and the associated location from the geolocation device can be stored in a database. A query for the identifier can be received from a second computing device. A map application can display the location associated with the identifier of the object.

### CROSS-REFERENCE TO RELATED APPLICATION

This application claims priority to U.S. Provisional Patent Application No. 63/391,426, filed Jul. 22, 2022, the entirety of which is hereby incorporated by reference herein.

### FIELD

This disclosure relates apparatuses for tracking the respective locations of a plurality of vehicles or vehicle components.

### BACKGROUND

In certain applications, vehicles in a fleet can be interchangeably operated by different operators. In these applications, tracking the location of the vehicles can be difficult. Similarly, for applications such as, for example, multi- and final stage manufacturing, in which vehicle components (e.g., a body, a chassis, etc.) are used and interchanged, a need exists for the vehicle components to be tracked. Accordingly, a system for tracking the location of vehicles of a fleet is desirable. Similarly, a system for tracking the location of components of vehicles is desirable.

### SUMMARY

Disclosed herein, in one aspect, is a method comprising receiving, from a first computing device comprising a geolocation device, an identifier associated with an object, wherein the object is a vehicle or component of a vehicle. The identifier associated with the object is associated with a location from the geolocation device by the first computing device. The identifier associated with the vehicle and the associated location from the geolocation device is stored in a database. A query for the identifier is received from a second computing device. The location associated with the identifier of the object is displayed by a map application.

In another aspect, a system comprises a plurality of objects. Each object is a vehicle or a component of a vehicle. Each object of the plurality of objects comprises a respective identifier. A computing network comprises a first computing device, a second computing device, and a central database in communication with each of the first and second computing devices. Each of the first and second computing devices comprises a geolocation device. The first computing device is configured to receive the respective identifier associated with an object of the plurality of objects, and associate a location from the geolocation device of the first computing device with the object. The central database is configured to store the identifier associated with the object and the associated location from the geolocation device. The second computing device is configured to receive an input of the respective identifier of the object, receive the location associated with the object from the central database, and display, by a map application, the location associated with the identifier of the object.

Additional advantages of the disclosed system and method will be set forth in part in the description which follows, and in part will be understood from the description, or may be learned by practice of the disclosed system and method. The advantages of the disclosed system and method will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed apparatus, system, and method and together with the description, serve to explain the principles of the disclosed apparatus, system, and method.

FIG. 1 is a block diagram of a system as disclosed herein.

FIG. 2 is a block diagram of an operating environment comprising a computing device as disclosed herein.

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a,” “an,” and “the” does not exclude plural referents unless the context clearly dictates otherwise. Thus, for example, reference to “a vehicle” does not exclude the possibility of more than one of such vehicles, and so forth. Thus, where “a vehicle” is disclosed, it is contemplated that in some aspects, only one vehicle can be provided, while in other aspects, a plurality of vehicles can be provided.

As used herein “or” should be understood to be an inclusive or unless context dictates otherwise. For example, when separating items in a list, “or” should be interpreted as being inclusive, i.e., the inclusion of at least one, but also including more than one, of a number or list of elements, and, optionally, additional unlisted items.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values or characteristics are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

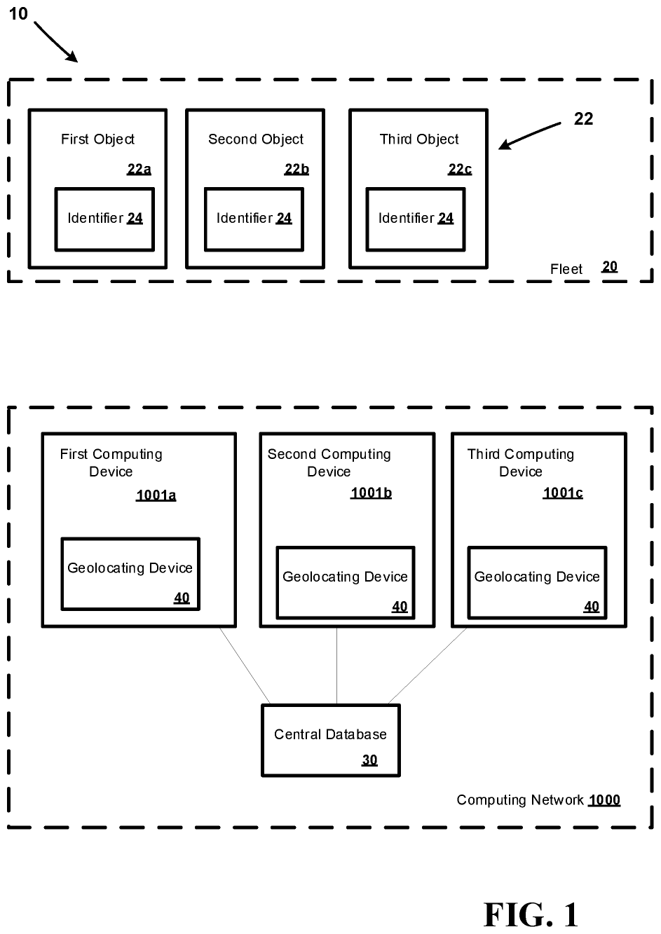

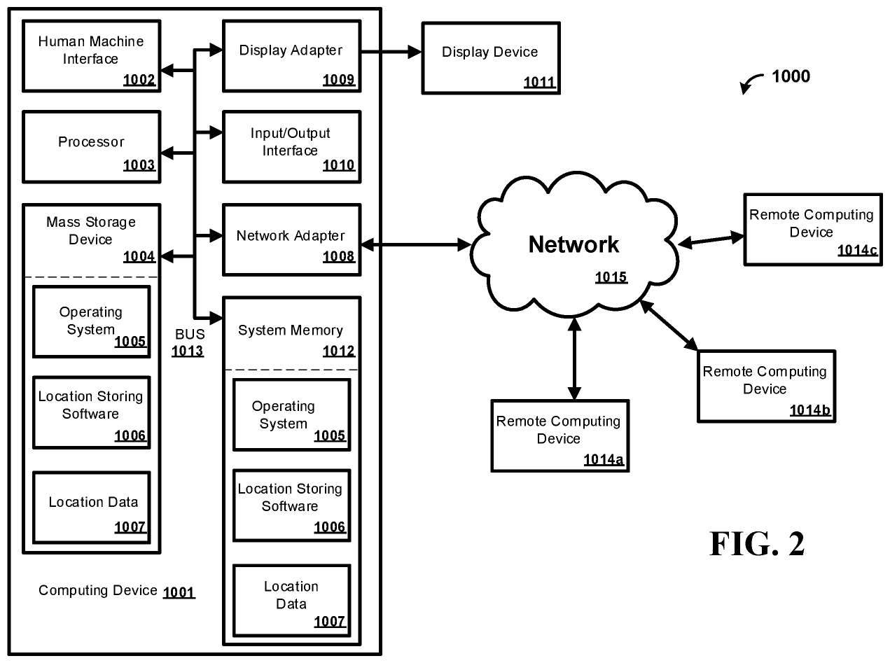

Disclosed herein, and with reference to FIGS. 1-2, is a system 10 for tracking object or component locations (e.g., vehicle or vehicle component locations). The system 10 can comprise a plurality of vehicles 22 (e.g., a fleet 20). In other aspects, the system 10 can comprise a plurality of vehicle components (e.g., chassis, lift gates, hoods, or other (optionally, significant) vehicle components). For example, the plurality of vehicles can comprise a first vehicle 22a, a second vehicle 22b, and a third vehicle 22c. Optionally, in exemplary aspects, the plurality of vehicles can comprise a plurality of delivery vehicles (e.g., delivery trucks or delivery vans). For exemplary purposes, embodiments of this disclosure refer to vehicles. However, it should be understood that this disclosure further includes embodiments in which components of a vehicle (as opposed to vehicles themselves) are tracked using the disclosed systems and methods. Thus, wherever the term vehicle is used, another embodiment should be understood to be disclosed in which the term vehicle is replaced with vehicle component. Each vehicle 22 of the plurality of vehicles can comprise a respective identifier 24. In some optional aspects, the identifier 24 can comprise an optically capturable identifier. For example, the optically capturable identifier can comprise a barcode, a QR code, or the like. In further aspects, the identifier 24 can comprise an alphanumeric identifier (e.g., a license plate number). In yet further aspects, the identifier 24 can comprise a radio frequency identifier (RFID) indicator. Optionally, the identifier 24 can comprise a plurality of identifying data. For example, the identifier can comprise a combination of a barcode, an alphanumeric identifier, and an RFID indicator. In some aspects, identifying data can comprise a vehicle identification number (VIN), serial number, work order identifier, and/or sales order identifier (e.g., an alphanumeric string). The plurality of identifying data can be associated with each other so that knowledge of one type of identifying data can be used to determine the other identifying data. For example, the plurality of identifying data can be stored in a central database (further disclosed herein) and linked together so that the identifying data can be searchable. Some or all of the identifying data can be manually entered into the system 10. In further aspects, some or all of the identifying data can be entered into the system 10 via optical scanning.

A computing system 1000 can comprise a first computing device 1001a, a second computing device 1001b, and a central database 30 (a computing device for accessing and storing structured data) in communication with each of the first and second computing devices. Each of the first and second computing devices can comprise a geolocation device 40 (e.g., a global positioning system (GPS)). In exemplary aspects, the first and second computing devices 1001a,b can be, for example, smartphones, tablets, or handheld scanners. In these aspects, the first and second computing devices 1001a,b can comprise applications that permit interfacing with the rest of the computing system 1000.

The first computing device 1001a can be configured to determine and associate a location (e.g., latitude and longitude coordinates) of the first vehicle 22a. This step can be performed, for example, when parking the first vehicle in order to log the location where the vehicle is parked. In other aspects, this step can be performed when placing or storing a component of a vehicle such as a chassis. In this way, at a later time, the location of the first vehicle can be recalled for the same operator or for a different operator.

The first computing device 1001a can be configured to: receive the respective identifier associated with the first vehicle 22a of the plurality of vehicles; and associate a location from the geolocation device of the first computing device with the vehicle. For example, the first computing device 1001a can be configured to scan a barcode identifier (or other optically capturable identifier). Accordingly, in some aspects, the computing device 1001a can comprise a camera that is configured to capture the barcode identifier (or other optically capturable identifier). In other aspects, the user can type in (or dictate) the identifier 24 or select the identifier from a menu (e.g., a dropdown list). Upon receiving the identifier 24 (or within a predetermined time period thereafter), the first computing device 1001a can be configured to associate the location from the geolocation device of the first computing device 1001a with the first vehicle 22a. The location of the first computing device 1001a at the time of receiving the identifier 24 can correspond to the location of the first vehicle 22a itself. In this way, the first vehicle 22a need not have its own geolocation device. This can be advantageous, as vehicles need not be equipped with an expensive geolocation device and computing device for accessing the system. Thus, it is unnecessary to install a geolocation device that is permanently associated with the vehicle. By omitting geolocation devices from the vehicle or other object, the following advantages are contemplated:
Parasitic electrical loads from a geolocation or other tracking device that drain battery can be omitted;
The identifier can easily be integrated with various objections and for various applications because an external power source is not required.
The identifier can be used on a very large volume of inventory items (e.g. chassis, hoods, liftgates, large frame weldments, and a variety of components and assemblies both in and outside the automotive industry.)
Through the use of smart barcodes, or QR codes, a single system can track any number of different component types.
Through the use of complimentary application software, detailed inventory maps can be created and communicated to different users (e.g., customers and/or unrelated departments within an organization).

Further, in some situations, wireless communication service (e.g., cell phone service) can be unavailable, even though the geolocation device can establish a location. It is contemplated that, using the disclosed system, the vehicle can be associated with a location (e.g., temporarily stored on the first computing device 1001a), and the location can later be provided to the central database once communication can be established with the first computing device 1001a.

In some aspects, the location can further be associated with a time at which the location is associated with the vehicle. Accordingly, the vehicle location and time at which the vehicle location was determined can be logged.

Optionally, the first computing device 1001a (and each other computing device) can have a computing device identifier associated therewith. In these aspects, the computing device identifier of the first computing device 1001a can be associated with the object in the central database 30. In this way, the first computing device 1001a can be identified. The computing device identifier can be any suitable identifier including, for example, an alphanumeric identifier.

The central database 30 can be configured to store the identifier associated with the vehicle and the associated location from the geolocation device. The central database 30 can be accessed by the same computing device (first computing device 1001a) or other computing devices in order to permit the computing devices in communication with the central database 30 to save and determine locations of vehicles 22 of the plurality of vehicles and/or other relevant data (e.g., VIN, serial number, work order identifier, sales order identifier, identification number associated with user who last entered the location of the vehicle, and/or identifier associated with the computing device or geolocation device that last entered the location of the vehicle). In some optional aspects, the system 10 can use MICROSOFT POWER AUTOMATE job to store the data in a MICROSOFT SharePoint list. In this way, the data stored can be accessed by any user granted the appropriate rights via MICROSOFT ACTIVE DIRECTORY software and MICROSOFT SHAREPOINT software (e.g., users of the first and second computing devices 1001a,b, as further disclosed herein). In further aspects, custom-designed software can associate and store data as well as receive data and respond to queries. It is contemplated that custom-designed software can omit undesirable features, such as external login accounts and unnecessary libraries and software that lead to unnecessary processing consumption. Further, the custom-designed software can permit integration of various additional features, such as, for example, post-scanning processing features, such as data mining and historical shipping & receiving reporting.

The second computing device 1001b (e.g., a computing device of another operator) can be configured to: receive an input of the respective identifier of the vehicle; and display, by a map application, the location associated with the identifier of the vehicle. For example, an operator can scan an optically capturable identifier or type in the identifier of the first vehicle 22a or select the identifier of the vehicle from a menu (e.g., a dropdown list). The second computing device 1001b can, in response to receiving the respective identifier of the first vehicle, launch the map application (e.g., GOOGLE MAPS application, APPLE MAPS application, or WAZE application, or the like). Although embodiments herein disclose launching a map application, in other aspects, any suitable application for providing location information can be launched. For example, in another aspect, after receiving an input of the respective identifier of the vehicle, the second computing device can launch an application that copies or displays an address or geographic coordinates for the object, or provides a geolocation pin (e.g., coordinates or an address) that can be used to obtain the location of the object. In this way, for example, a dispatcher (or other party) can retrieve the location of the object via the second computing device and send the object to another computing device (e.g., a smartphone of a truck operator).

In some aspects, the second computing device 1001b can be further configured to display, by the map application, directions to the location associated with the identifier of the vehicle (or vehicle component). In still further aspects, the second computing device 1001b can be further configured to track the location of the second computing device 1001b.

In this way, the second computing device can direct an operator (e.g., a second operator who is different from the operator that saved the location of the vehicle) to the first vehicle 22a.

In addition to receiving information concerning the location of the vehicle (or other item), it is contemplated that the second computing device 1001b can also receive other vehicle- or item-related information stored by the central database 30, including, for example and without limitation, VIN, serial number, work order identifier, sales order identifier, identification number associated with user who last entered the location of the vehicle, and/or identifier associated with the computing device or geolocation device that last entered the location of the vehicle. It is contemplated that this additional information can provide the user of the second computing device with more details concerning the history of the vehicle (or other item).

### Method of Use

A method can comprise receiving, from a first computing device 1001a comprising a geolocation device 40, an identifier 24 associated with a first vehicle 22a (or a component thereof). The first computing device 1001a can associate the identifier 24 associated with the first vehicle 22a (or component thereof) with a location from the geolocation device 40. For example, the first computing device 1001a can provide both the identifier 24 and the location to the central database 30 as disclosed herein The identifier 24 associated with the first vehicle 22a (or component thereof) and the associated location from the geolocation device can be stored in the database. A second computing device 1001b can receive an query for the identifier 24. For example, a user can input the identifier 24 into the second computing device 1001b (e.g., via scanning the identifier, selecting the identifier, or typing in the identifier). The second computing device 1001b can receive the location associated with the object from the central database 30. The location associated with the identifier 24 of the first vehicle 22a (or component thereof) can be displayed by a map application (e.g., relative to a current location of the second computing device 1001b).

In some aspects, the method can further comprise receiving, from a third computing device 1001c comprising a geolocation device 40, an identifier 24 associated with a second vehicle 22b (or component thereof). The identifier 24 associated with the second vehicle 22b (or component thereof) can, by the computing device 1001c, be associated with a second location from the geolocation device of the third computing device 1001c.

### Computing Device

FIG. 2 shows a computing system 1000 including an exemplary configuration of an exemplary computing device 1001 for use with the system 10 (FIG. 1) for tracking vehicle locations. Each of the database 30, the first computing device 1001a, second computing device 1001b, third computing device 1001c, and additional computing devices can be configured as disclosed herein with reference to the computing device 1001.

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as location data 1007 and/or program modules such as operating system 1005 and location storing software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and location storing software 1006 may be stored on the mass storage device 1004. One or more of the operating system 1005 and location storing software 1006 (or some combination thereof) may comprise program modules and the location storing software 1006. The location data 1007 may also be stored on the mass storage device 1004. The location data 1007 may be stored in any of one or more databases known in the art. The databases may be centralized or distributed across multiple locations within the network 1015.

A user may enter commands and information into the computing device 1001 using an input device. Such input devices comprise, but are not limited to, a joystick, a touchscreen display, a keyboard, a pointing device (e.g., a computer mouse, remote control), a microphone, a scanner, tactile input devices such as gloves, and other body coverings, motion sensor, speech recognition, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In various further aspects, it is contemplated that some or all aspects of data processing described herein can be performed via cloud computing on one or more servers or other remote computing devices. Accordingly, at least a portion of the system 1000 can be configured with internet connectivity. In exemplary aspects, the computing device 1001 of FIG. 2 can correspond to the central database 30 (FIG. 1), and the first, second, and third remote computing devices 1014a,b,c can correspond to the first, second, and third computing devices 1001a,b,c.

Those skilled in the art will recognize, or be able to ascertain using no more than routine experimentation, many equivalents to the specific embodiments of the method and compositions described herein. Such equivalents are intended to be encompassed by the following claims.

What is claimed is:

1. A method comprising:
receiving, from a first computing device comprising a geolocation device, an identifier associated with an object, wherein the object is a vehicle or component of a vehicle;
associating, by the first computing device, the identifier associated with the object with a location from the geolocation device;
storing, in a database, the identifier associated with the vehicle and the associated location from the geolocation device;
receiving, from a second computing device, a query for the identifier; and
displaying, by a map application, the location associated with the identifier of the object.

2. The method of claim 1, wherein the first and second computing devices are smartphones.

3. The method of claim 1, wherein the geolocation device is a GPS device.

4. The method of claim 1, further comprising displaying, by the map application, directions to the location associated with the identifier of the object.

5. The method of claim 4, further comprising tracking the location of the second computing device.

6. The method of claim 1, wherein the identifier comprises an optically capturable identifier.

7. The method of claim 6, wherein the optically capturable identifier comprises a barcode.

8. The method of claim 1, wherein the identifier comprises an alphanumeric identifier.

9. The method of claim 1, wherein the identifier comprises an RFID indicator.

10. The method of claim 1, wherein the identifier comprises a plurality of identifying data.

11. The method of claim 1, wherein the object is a first object, the method further comprising:
receiving, from a third computing device comprising a geolocation device, an identifier associated with a second object; and
associating, by the third computing device, the identifier associated with the second object with a second location from the geolocation device of the third computing device.

12. The method of claim 1, further comprising associating a computing device identifier of the first computing device with the object, and wherein the first computing device is not physically installed within or secured to the object.

13. A system comprising:
a plurality of objects, wherein each object is a vehicle or a component of a vehicle, wherein each object of the plurality of objects comprises a respective identifier;
a computing network comprising a first computing device, a second computing device, and a central database in communication with each of the first and second computing devices, wherein each of the first and second computing devices comprises a geolocation device, wherein:
the first computing device is configured to:
receive the respective identifier associated with an object of the plurality of objects;
associate a location from the geolocation device of the first computing device with the object;
the central database is configured to:
store the identifier associated with the object and the associated location from the geolocation device;
the second computing device is configured to:
receive an input of the respective identifier of the object;
receive the location associated with the object from the central database; and
display, by a map application, the location associated with the identifier of the object.

14. The system of claim 13, wherein the second computing device is further configured to display, by the map application, directions to the location associated with the identifier of the object from a current location of the second computing device.

15. The system of claim 14, wherein the second computing device is further configured to track the location of the second computing device.

16. The system of claim 13, wherein the respective identifier comprises an optically capturable identifier or an alphanumeric identifier.

17. The system of claim 16, wherein the respective identifier comprises an optically capturable identifier, wherein the optically capturable identifier comprises a barcode.

18. The system of claim 13, wherein the respective identifier comprises an RFID indicator.

19. The system of claim 13, wherein the respective identifier comprises a plurality of identifying data.

20. The system of claim 13, wherein the central database is configured to associate a computing device identifier of the first computing device with the object, and wherein the first computing device is not physically installed within or secured to the object.
